(19) United States
(12) Patent Application Publication
(10) Pub. No.: US 2007/0122222 A1
(43) Pub. Date: May 31, 2007

(54) PLATEN ROLLER HOLDING STRUCTURE

(75) Inventors: Kazutaka Suzuki, Fukushima-ken (JP); Hiroyuki Murayama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/562,255

(22) Filed: Nov. 21, 2006

(30) Foreign Application Priority Data
Nov. 25, 2005 (JP) 2005-340636

(51) Int. Cl. B41J 2/315

(52) U.S. Cl. 400/120.02

(57) ABSTRACT

A protrusions are formed on the periphery of the bearing plates rotatably holding a rotation shaft of the platen roller at both ends of the rotation shaft, and the protrusions protrude outward from portions of the bearing plates facing each other. The protrusions of the bearing plates facing each other are connected with each other by connecting members such that an interval is formed between the platen roller and each of the connecting members.

### BACKGROUND OF THE INVENTION

1. Field of the Invention

The present invention relates to a platen roller holding structure of a thermal transfer printer in which a plurality of thermal heads are detachably disposed to a platen roller at predetermined intervals in a circumferential direction of the platen roller, and particularly to a platen roller holding structure capable of preventing bearing plates which hold the platen roller from bending due to a load generated when each of the thermal heads is pressed against the platen roller.

2. Description of the Related Art

In a related art, a thermal printer in which a plurality of thermal heads are disposed to a platen roller at predetermined intervals in a circumferential direction of the platen roller has been known as a thermal printer which ensures high speed and high quality during printing.

In the thermal printer according to the related art, a platen roller is rotatably held by a platen roller holding structure having a pair of bearings disposed facing each other in a case, and the platen roller is rotatably driven due to the rotation of a driving source composed of a stepping motor by a driving gear.

On an outer periphery of the platen roller, four thermal heads are detachably disposed to the platen roller, respectively, at constant intervals in a circumferential direction of the platen roller, and ink ribbons on which ink layers of cyan (C), magenta (M), yellow (Y), black (K) are formed and are drawn between the platen roller and each thermal head.

By rotatably driving the platen roller, a print medium is conveyed between the platen roller and each thermal head by each ink ribbon, and each thermal head is pressed against the platen roller with each ink ribbon and the print medium interposed therebetween, and then a plurality of heat emitting elements are selectively heated, thus obtaining a full color printing (see JP-A-2003-291388).

However, in the thermal printer according to the related art, if printing is repeatedly performed, a load generated when each thermal head is pressed against the platen roller with each ink ribbon and the print medium interposed therebetween causes the platen roller holding structure holding the platen roller to bend. As a result, the platen roller bends, thus deteriorating printing quality.

### SUMMARY OF THE INVENTION

An object of the invention is to provide a platen roller holding structure capable of preventing a platen roller from bending due to a load generated when a plurality of thermal heads is pressed against the platen roller, in a thermal printer in which the plurality of thermal heads is detachably disposed to one platen roller.

In order to achieve the above-described object, according to an aspect of the invention, a platen roller holding structure for holding a platen roller of a thermal printer that includes a plurality of thermal heads detachably disposed to the periphery of the platen roller at predetermined intervals in a circumferential direction. Further, the platen roller holding structure includes a plurality of protrusions that are formed on the periphery of the bearing plates for rotatably holding a rotation shaft of the platen roller at both ends of the rotation shaft. The protrusions protrude outward from portions of the bearing plates facing each other. In this case, the protrusions of the bearing plates facing each other are connected with each other by connecting members such that an interval is formed between the platen roller and each of the protrusions.

With this structure, rigidity of the bearing plates is enhanced, and it is possible to prevent the bearing plates from bending although a load is generated when each of the thermal heads is pressed against the platen roller. As a result, it is possible to perform high quality printing.

In the platen roller holding structure according to the aspect of the invention, each of the thermal heads may be disposed between each pair of the connecting members in a circumferential direction of the platen roller.

With this structure, since each of the thermal heads is disposed between a pair of the connecting members in the circumferential direction of the platen roller, it may be possible to prevent displacement of a portion of the platen roller where each thermal head is pressed against the platen roller.

### BRIEF DESCRIPTION OF THE DRAWINGS

FIG. 1 is a perspective view schematically showing a platen roller holding structure according to an embodiment of the invention; and

FIG. 2 is a schematic view showing main parts of a thermal printer using the platen roller holding structure of FIG. 1.

### DESCRIPTION OF THE PREFERRED EMBODIMENT

Hereinafter, a platen roller holding structure according to an embodiment of the invention will be described, with reference to the accompanying drawings. The same elements or parts throughout the drawings are designated by the same reference characters.

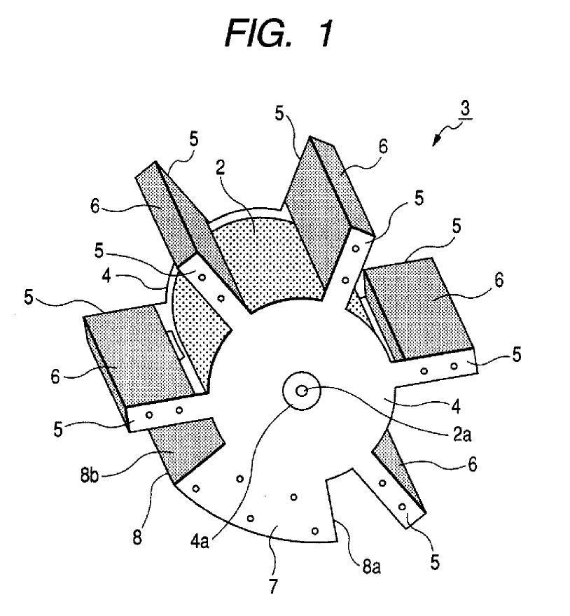

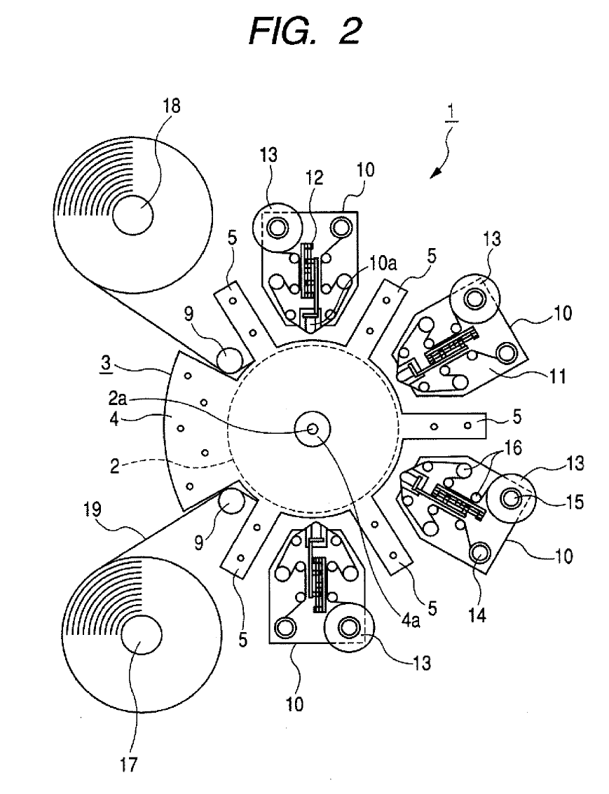

FIG. 1 is a perspective view schematically showing a platen roller holding structure according to an embodiment of the invention, and FIG. 2 is a schematic view showing main parts of a thermal printer using the platen roller holding structure of FIG. 1.

As shown in FIG. 2, according to the embodiment, in a thermal printer 1, a platen roller 2 is rotatably held in a platen roller holding structure 3, which is disposed in a case (not shown).

On an outer periphery of the platen roller 2, four thermal heads 10 are detachably disposed to the platen roller 2 at predetermined intervals in a circumferential direction of the platen roller 2, and an ink ribbon 13 is drawn between each thermal head 10 and the platen roller 2.

The platen roller 2 is geared with a driving source (not shown) like a stepping motor through a driving gear (not shown), which is disposed to a rotation shaft 2a, and it can be rotated due to rotation of the driving source. Meanwhile, according to this embodiment, the normal rotation direction of the platen roller 2 is in a counter-clockwise direction.

According to this embodiment, the platen roller holding structure 3 includes a pair of bearing plates 4 and 4 formed in a circular shape having a larger outer diameter than the diameter of the platen roller 2, as shown in FIG. 1.

A bearing 4a is formed at the center of each of the bearing plates 4 and 4, and both ends of the rotation shaft 2a of the platen roller 2 are rotatably held by both bearings 4a.

Five protrusions 5 are formed in a rectangular shape on the periphery of the bearing plates 4 and 4, respectively, so as to face each other at opposite sides, and to be positioned between a pair of thermal heads 10 in the circumferential direction of the bearing plates 4 and 4. The five protrusions 5 protrude outward with respect to the radial direction of the platen roller 2, and the protrusions 5 facing each other are connected to each other by connecting members 6. Each of the protrusions 5 is disposed to the platen roller 2 with an interval therebetween.

Furthermore, on the periphery of a portion of the bearing plates 4 and 4 where the thermal head 10 does not exist, protrusions 7 are formed in a fan shape protruding outward so as to face each other between both bearing plates 4 and 4. Protrusions 7 are connected to each other by a connecting member 8 that is disposed to the platen roller 2 with an interval therebetween. Meanwhile, each of side surfaces 8a and 8b of the connecting member 8 is designed to guide a print medium 19 together with a guide roller 9 which is disposed inside the case when the print medium 19 such as recording paper is conveyed by the platen roller 2.

Each of the thermal heads 10 includes a plurality of heat emitting elements 10a which are disposed parallel to the axis of the platen roller 2, and each thermal head 10 is mounted on a carriage 12 which is disposed to a base 11 having a flat shaper so as to be attached to and detached from the platen roller 2 by a movable attaching and detaching cylinder.

Each of the ink ribbons 13 is wound around a take-up core 15 and a supply core 14 which are rotatably disposed to the base 11 on which the carriage 12 is mounted, and guided by a plurality of pinch rollers 16, so as to be drawn between the platen roller 2 and each of the thermal heads 10.

Each of the ink ribbons 13 is provided with an ink layer each having different colors. Ink layers of cyan (C), magenta (M), yellow (Y), and black (K) may be sequentially formed on the ink ribbons, from the ink ribbon 13 located in the uppermost position in a normal rotation direction of the platen roller 2 to the ink ribbon 13 located in the lowermost position.

On the outer periphery of the platen roller 2, the print medium 19 wound around a paper feed roller 17 and a take-up roller 18 is drawn around the platen roller 2.

In a print method using the thermal printer 1 constructed as described above according to this embodiment, the platen roller 2 and the take-up roller 18 are rotatably driven so as to feed the print medium 19. Then, each thermal head 10 is pressed against the platen roller 2 with each ink ribbon 13 and the print medium 19 interposed therebetween, and the heat emitting element 10a of each thermal head 10 is selectively heated, thereby printing out a full color image.

In the platen roller holding structure 3 according to the embodiment, the connecting members 6 and the connecting member 8 connect the protrusions 5 and the protrusions 7, which are formed to the bearing plates 4 and 4 and face each other between the bearing plates 4 and 4, respectively, which enhances rigidity of the bearing plates 4 and 4. Thus, even though printing is repeatedly performed, it is possible to prevent the bearing plates 4 and 4 from bending due to a load generated when each of the thermal heads 10 is pressed against the platen roller 2. As a result, it is possible to prevent the platen roller 2 from bending, thereby performing stable and high quality printing.

The invention is not limited to the above-described embodiment, and it can be modified in various forms within the spirit of the invention.

In the platen roller holding structure according to an embodiment of the invention, the rigidity of the bearing plates holding the platen roller can be enhanced. Thus, in a thermal printer where a plurality of thermal heads are attached to and detached from the platen roller, even though printing is repeatedly performed, it is possible to prevent the bearing plates from bending due to a load generated when each of the thermal heads is pressed against the platen roller. As a result, it is possible to prevent the platen roller from bending, thereby performing stable and high quality printing.

The invention has been explained by the embodiment described herein; however, those skilled in the art will readily appreciate that many modifications are possible in the exemplary embodiment without materially departing from the novel teachings and advantages of the invention. Accordingly, all such modifications are intended to be included within the scope of this invention as defined in the following claims.

What is claimed is:

1. A platen roller holding structure for holding a platen roller of a thermal printer that includes thermal heads detachably disposed to the periphery of the platen roller at predetermined intervals in a circumferential direction, the platen roller holding structure comprising:
protrusions formed on the periphery of bearing plates for rotatably holding a rotation shaft of the platen roller at both ends of the rotation shaft,
wherein the protrusions of the bearing plates facing each other are connected with each other by connecting members such that an interval is formed between the platen roller and each of the connecting members.

2. The platen roller holding structure according to claim 1,
wherein each of the thermal heads is disposed between a pair of the connecting members in a circumferential direction of the platen roller.
